(19) United States
(12) Patent Application Publication
(10) Pub. No.: US 2003/0071533 A1
(43) Pub. Date: Apr. 17, 2003

(54) Self-starting synchronous motor and compressor using the same

(76) Inventors: Satoshi Kikuchi, Hitachi (JP); Haruo Koharagi, Juo (JP); Tomio Yoshikawa, Shimizu (JP); Akira Saruta, Chiba (JP); Susumu Nakayama, Shizuoka (JP); Miyoshi Takahashi, Hitachi (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/237,722

(22) Filed: Sep. 10, 2002

(30) Foreign Application Priority Data
Oct. 16, 2001 (JP) 2001-317911
Jul. 18, 2002 (JP) 2002-209264

(51) Int. Cl. H02K 17/16

(52) U.S. Cl. 310/211

(57) ABSTRACT

A self-starting synchronous motor and a compressor including the motor are disclosed. The self-starting synchronous motor comprises at least a squirrel-cage conductor buried in the neighborhood of the outer peripheral portion of a rotor core, and a plurality of permanent magnets buried in the periphery inward of the squirrel-cage conductor. The armature winding for the stator is wound in concentrated way, and the two ends of each of the teeth are expanded to form at least a disuniform gap between the stator and the rotor. At least an arcuate permanent magnet is buried in the rotor, and a squirrel-cage conductor is buried also between the magnetic poles.

### BACKGROUND OF THE INVENTION

The present invention relates to a self-starting synchronous motor with a permanent magnet, and a compressor using the motor.

The compressor with a motor and a scroll integrated and hermetically sealed in a housing includes either a variable speed compressor with the speed thereof controlled by a separate inverter or a constant speed compressor operated at a constant rotational speed with power supplied directly from a power supply of a constant voltage and a constant frequency.

The constant speed compressor, which uses no inverter unit, has conventionally employed an induction motor having a cage winding for a rotor and capable of being started by itself.

In view of the low efficiency of the induction motor, however, JP-A-4-210758, JP-A-6-284660, JP-A-2001-78401, etc. propose a motor called a self-starting synchronous motor or an induction synchronous motor with permanent magnets buried in the cage winding, which is started and accelerated with the power torque as an induction motor and operated as a synchronous motor at the rated speed.

On the other hand, JP-A-2001-157427 discloses a self-starting synchronous motor comprising a stator having two armature windings of concentrated type and distributed type arranged side by side, so that the motor is started and accelerated as an induction motor using the armature winding of distributed type, and switched to a synchronous motor having the armature winding of concentrated type at high speeds.

In the synchronous motor of permanent magnet type, the air gap between the stator and the rotor is formed as an unequal gap as disclosed in JP-A-8-111968 and JP-A-11-89197. The direction in which the permanent magnets are magnetized, on the other hand, is disclosed in JP-A-7-39090, JP-A-7-212994 and JP-A-10-126981.

The conventional self-starting synchronous motors described above are started and accelerated as a squirrel-cage induction motor. Therefore, the stator of all of them has an armature winding of distributed type and the winding length per turn is so large as to cause a large copper loss, which constitutes a stumbling block to a higher efficiency. Also, the provision of the armature winding of distributed type lengthens the coil end portion and increases the motor size. This makes it difficult to decrease the size of the body of the compressor, for example, to which the motor is applicable. Further, the production equipment of large scale is required, thereby posing the problem of an increased cost.

The technique disclosed in JP-A-2001-157427 poses the problem of an increased cost in view of the additional facts that an independent change-over switch is required and that winding machines for both concentrated winding and distributed winding are required on the production line. Also, since the armature winding of distributed type used only for starting is wound in two poles (2n poles) while the magnets are arranged in four poles (4n poles), the magnetic fluxes of four poles interlink with the two-pole winding. Thus, a harmonic component having a double frequency is generated at the time of starting. This is considered to deteriorate the starting torque characteristic. Further, an annular conductor like a pipe used as a starting conductor for the rotor causes a magnetic gap and reduces the effective magnetic fluxes at the time of the operation at the rated speed, thereby leading to a deteriorated characteristic. Also, the current induced in the conductor at the time of starting is distributed in eddy form, and cannot interlink at right angles with the magnetic fluxes on the stator side. Therefore, an effective starting torque cannot be secured. Further, an additional assembly line is required for the rotor, which disadvantageously increases the cost.

### SUMMARY OF THE INVENTION

The object of the present invention is to provide a self-starting synchronous motor (induction synchronous motor) for driving a compact, highly efficient compressor and the compressor driven using the same motor.

The self-starting (induction) synchronous motor comprises a squirrel-cage winding and is started and accelerated using the torque as an induction motor, and when a rated speed is reached, operated using the torque as a synchronous motor with a field system of permanent magnets or electromagnets. For this reason, the armature coil of distributed winding type has been considered essential for obviating the problems including (1) the torque pulsation, (2) the loss and (3) and the adverse effect on the power supply as an induction motor, as described in the patent publications described above. The study by the present inventor shows, however, that the rated speed (or thereabouts) can be reached within one second after starting and acceleration as an induction motor, and if the problems of (1), (2) and (3) described above can be obviated or alleviated only within this short time, the subsequent operation as a highly efficient synchronous motor is made possible.

In view of this, according to one aspect of the invention, there is provided a self-starting synchronous motor started and accelerated with the torque of an induction motor and operated at constant speed with the torque of a synchronous motor, in which the armature winding is concentrated.

Since the motor is started and accelerated with the torque of an induction motor having a concentrated armature winding as described above, there is provided a compact self-starting synchronous motor with a reduced size of the coil end portion.

According to another aspect of the invention, there is provided a self-starting synchronous motor started and accelerated with the torque of an induction motor and operated at constant speed with the torque of a permanent-magnet synchronous motor, in which the armature winding is concentrated and constitutes a three-phase winding of U, V and W phases.

According to still another aspect of the invention, there is provided a self-starting synchronous motor, in which the armature winding is concentrated and constitutes a two-phase or a single-phase winding including a main winding and an auxiliary winding.

According to yet another aspect of the invention, there is provided a self-starting synchronous motor, in which the armature winding is concentrated and a squirrel-cage conductor is inserted between the poles of the permanent magnets.

According to a further aspect of the invention, there is provided a self-starting synchronous motor, in which the armature winding is concentrated and an unequal gap is formed between the stator and the rotor.

According to a preferred embodiment of the invention, a self-starting synchronous motor comprises a concentrated armature winding in a plurality of slots of the stator core, a squirrel-cage winding formed by burying a conductive material in a plurality of slots in the neighborhood of the outer peripheral portion of the rotor core, and a plurality of substantially arcuate permanent magnets buried in the inner peripheral side of the squirrel-cage winding.

These add up to a means for alleviating the torque pulsation, the loss and the adverse effect on the power supply at the time of starting and acceleration as an induction motor, thereby making it possible to produce a compact, highly efficient self-starting synchronous motor.

The invention also proposes a compressor having the self-starting synchronous motor described above.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a diametrical sectional structure of a self-starting synchronous motor according to an embodiment of the invention.

FIG. 2 is a diagram showing a diametrical sectional structure of a self-starting synchronous motor according to another embodiment of the invention.

FIG. 3 is a diagram showing a diametrical sectional structure of a self-starting synchronous motor according to still another embodiment of the invention.

FIG. 4 is a diagram showing a diametrical sectional structure of a self-starting synchronous motor according to yet another embodiment of the invention.

FIG. 5 is a diagram showing a diametrical sectional structure of a self-starting synchronous motor according to a further embodiment of the invention.

FIG. 6 is a diagram showing a diametrical sectional structure of a self-starting synchronous motor according to a still further embodiment of the invention.

FIG. 7 is a further showing a diametrical sectional structure of a self-starting synchronous motor according to a yet further embodiment of the invention.

FIG. 8 is a diagram showing a diametrical sectional structure of a self-starting synchronous motor according to another embodiment of the invention.

FIG. 9 is a diagram showing a diametrical sectional structure of a self-starting synchronous motor according to still another embodiment of the invention.

FIG. 10 is a diagram showing a diametrical sectional structure of a self-starting synchronous motor according to yet another embodiment of the invention.

FIG. 11 is a diagram showing a diametrical sectional structure of a self-starting synchronous motor according to a further embodiment of the invention.

FIG. 12 is a diagram showing a diametrical sectional structure of a self-starting synchronous motor according to a still further embodiment of the invention.

FIG. 13 is a diagram showing a diametrical sectional structure of a self-starting synchronous motor according to a yet further embodiment of the invention.

FIG. 14 is a diagram showing a diametrical sectional structure of a self-starting synchronous motor according to still another embodiment of the invention.

FIG. 15 is a diagram showing a diametrical sectional structure of a self-starting synchronous motor according to yet another embodiment of the invention.

FIG. 16 is a diagram showing a diametrical sectional structure of a self-starting synchronous motor according to a further embodiment of the invention.

FIG. 17 is a diagram showing a diametrical sectional structure of a self-starting synchronous motor according to a still further embodiment of the invention.

FIG. 18 is a diagram showing a diametrical sectional structure of a self-starting synchronous motor according to a yet further embodiment of the invention.

FIG. 19 is a diagram showing a diametrical sectional structure of a self-starting synchronous motor according to still another embodiment of the invention.

FIG. 20 is a diagram showing a diametrical sectional structure of a self-starting synchronous motor according to yet another embodiment of the invention.

FIG. 21 is a diagram showing a diametrical sectional structure of a self-starting synchronous motor according to a further embodiment of the invention.

FIG. 22 is a diagram showing a diametrical sectional structure of a self-starting synchronous motor according to a still further embodiment of the invention.

FIG. 23 is a diagram showing a sectional structure of a compressor according to an embodiment of the invention.

### DETAILED DESCRIPTION OF THE INVENTION

Embodiments of the invention will be explained below with reference to the accompanying drawings.

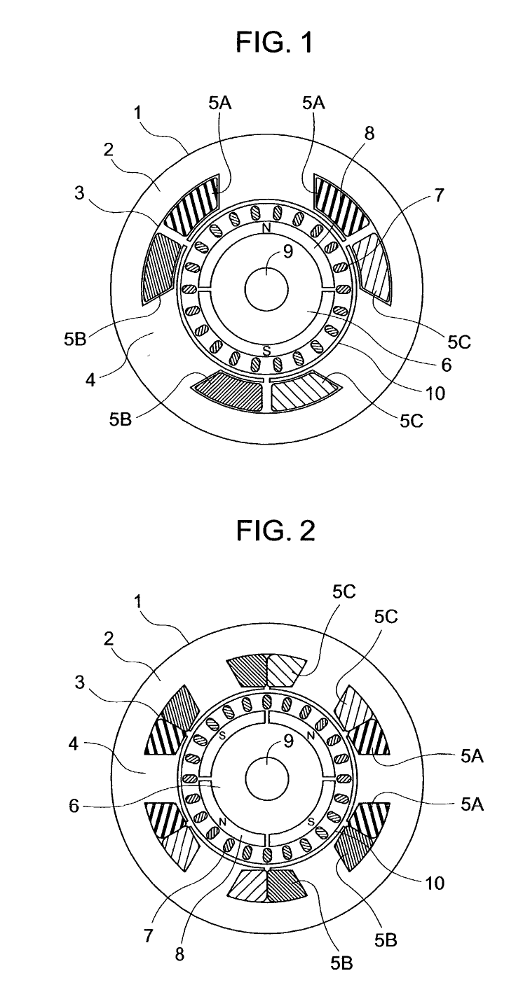

FIG. 1 is a diagram showing a diametrical sectional structure of a self-starting synchronous motor according to an embodiment of the invention. The self-starting synchronous motor comprises a stator 1 and a rotor 10. The stator 1 includes a stator core 2, three slots 3 formed therein and three teeth 4 divided by the slots 3. The armature winding 5 is wound in concentrated way on the teeth 4 using the slots 3. In FIG. 1, the armature winding 5 constitutes a three-phase winding including a U-phase winding 5A, a V-phase winding 5B and a W-phase winding 5C. Power is fed from an AC power supply (feeding means) of a predetermined frequency over the entire speed range from the starting and acceleration with the torque of an induction motor to the operation at constant speed as a synchronous motor.

In the rotor 10, a rotor core 6 having squirrel-cage conductors 7 and permanent magnets 8 are fixed on a crankshaft 9. A plurality of the squirrel-cage conductors 7 are for starting the motor as a squirrel-cage induction motor, while the permanent magnets 8 are for the operation at a rated speed as a synchronous motor. The permanent magnets 8 assume an arcuate form concentric with the crankshaft 9 and are buried in the rotor core 6 by being divided into two parts to constitute two magnetic poles. This self-starting synchronous motor with the field system of the permanent magnets has a “2-pole 3-slot” structure in which the three slots 3 and the two permanent magnets 8 are buried in the stator core 2 and the rotor core 6, respectively.

The armature winding 5 (5A, 5B, 5C) is wounded in concentrated way on the teeth 4 of the stator core 2 and accommodated in the slots 3.

With this configuration, the length of the armature winding 5 can be minimized and so can the winding resistance. Therefore, the copper loss during the operation is reduced for a higher efficiency. Also, the coil end portion can be reduced in size, and therefore the motor itself and the compressor or the like used with the motor can be made smaller. Further, as compared with the distributed winding, the production equipment is simplified. An experiment shows that the efficiency is improved by 3% over the distributed winding employed for the armature winding 5 shown in FIG. 1.

FIG. 2 is a diagram showing a diametrical sectional structure of a self-starting synchronous motor according to another embodiment of the invention. In FIG. 2, the same component parts as those in FIG. 1 are designated by the same reference numerals, respectively, as in FIG. 1 and will not be explained again. The component parts shown in FIG. 2 differently configured from those in FIG. 1 are six slots 3 formed in the stator core 2 and four permanent magnets 8 of different polarities buried in the rotor core 6 thereby to make up what is called a “4-pole 6-slot” structure.

This configuration can produce a similar effect to that of FIG. 1.

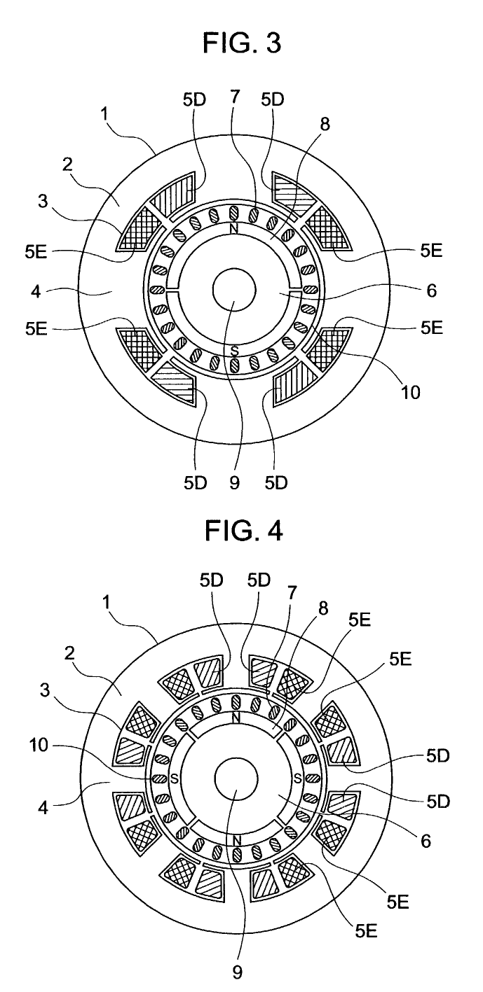

FIG. 3 is a diagram showing a diametrical sectional structure of a self-starting synchronous motor according to still another embodiment of the invention. In FIG. 3, the same component parts as those in FIG. 1 are designated by the same reference numerals, respectively, as in FIG. 1 and will not be explained again. The configuration of FIG. 3 is different from that of FIG. 1 in that four slots 3 are formed in the stator core 2, and the armature winding 5 in the slots 3 makes up a single-phase winding including a main winding 5D and an auxiliary winding 5E.

This configuration can produce a similar effect to that of FIG. 1.

FIG. 4 is a diagram showing a diametrical sectional structure of a self-starting synchronous motor according to yet another embodiment of the invention. In FIG. 4, the same component parts as those in FIG. 2 are designated by the same reference numerals, respectively, as in FIG. 2 and will not be explained again. The configuration of FIG. 4 is different from that of FIG. 2 in that eight slots 3 are formed in the stator core 2, and the armature winding 5 in the slots 3 makes up a single-phase winding including a main winding 5D and an auxiliary winding 5E.

This configuration can produce a similar effect to that of FIG. 2.

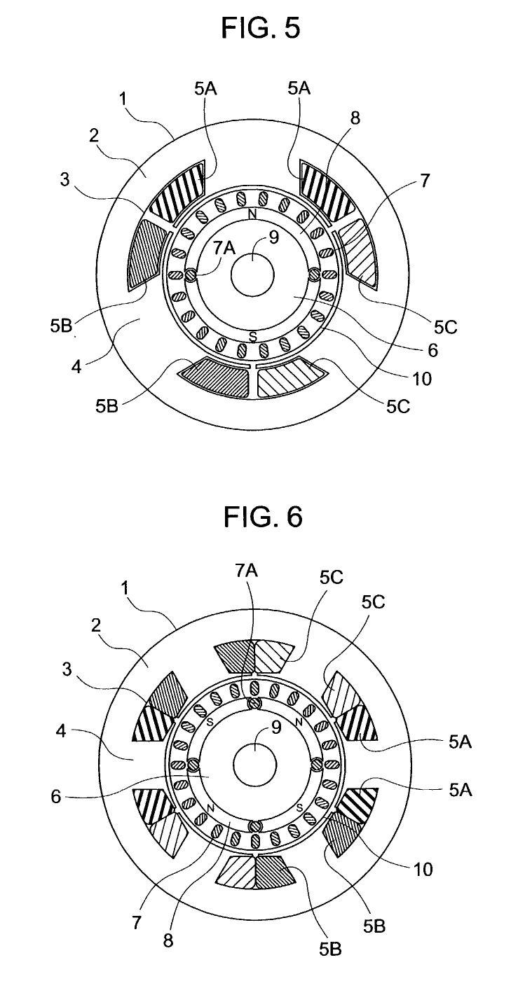

FIG. 5 is a diagram showing a diametrical sectional structure of a self-starting synchronous motor according to a further embodiment of the invention. In FIG. 5, the same component parts as those in FIG. 1 are designated by the same reference numerals, respectively, as in FIG. 1 and will not be explained again. The configuration of FIG. 5 is different from that of FIG. 1 in that a squirrel-cage conductor 7A is arranged between the two poles of each of two permanent magnets 8.

This configuration can produce a similar effect to that of FIG. 1. In addition, the torque can be increased as an induction motor, and the magnetic fluxes for armature reaction containing harmonics can be prevented from flowing into the rotor core 6 from between the poles, thereby making it possible to improve the efficiency further.

FIG. 6 is a diagram showing a diametrical sectional structure of a self-starting synchronous motor according to a still further embodiment of the invention. In FIG. 6, the same component parts as those in FIGS. 2 and 5 are designated by the same reference numerals, respectively, as in FIGS. 2 and 5, and will not be explained again. The configuration shown in FIG. 6 is different from those of FIGS. 2 and 5 in that six slots 3 are formed in the stator core 2 and four permanent magnets 8 of different polarities are buried in the rotor core 6 thereby to make what is called a “4-pole 6-slot” structure.

This configuration can produce a similar effect to that of FIG. 5.

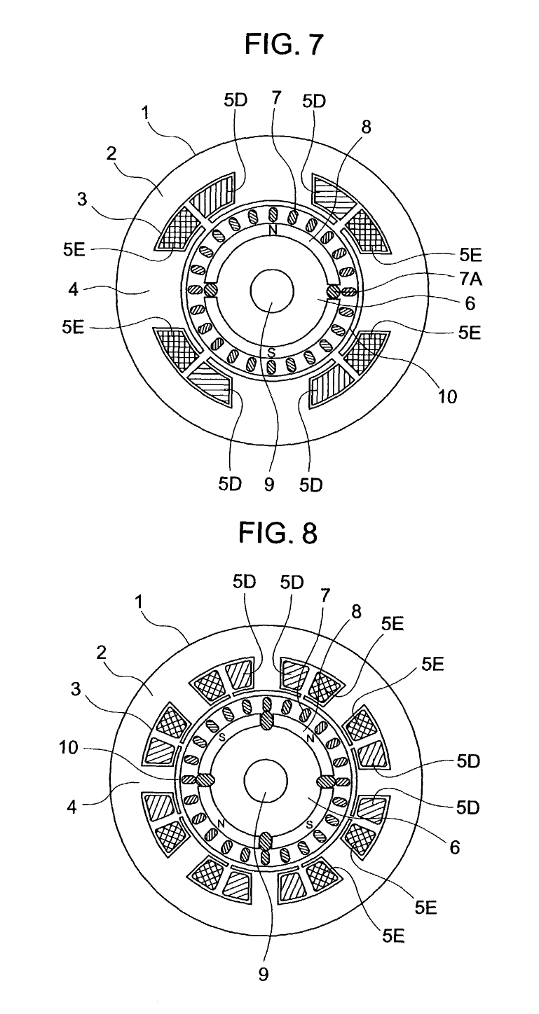

FIG. 7 is a diagram showing a diametrical sectional structure of a self-starting synchronous motor according to yet another embodiment of the invention. In FIG. 7, the same component parts as those in FIG. 5 are designated by the same reference numerals, respectively, as in FIG. 5 and will not be explained again. The configuration of FIG. 7 is different from that of FIG. 5 in that four slots 3 are formed in the stator core 2, and the armature winding 5 arranged in the slots 3 makes up a single-phase winding including a main winding 5D and an auxiliary winding 5E.

This configuration can produce a similar effect to that of FIG. 5.

FIG. 8 is a diagram showing a diametrical sectional structure of a self-starting synchronous motor according to a further embodiment of the invention. In FIG. 8, the same component parts as those in FIG. 6 are designated by the same reference numerals, respectively, as in FIG. 6 and will not be explained again. This configuration is different from that of FIG. 6 in that eight slots 3 are formed in the stator core 2 and the armature winding 5 arranged in the slots 3 makes up a single-phase winding including a main winding 5D and an auxiliary winding 5E.

This configuration can produce a similar effect to that of FIG. 6.

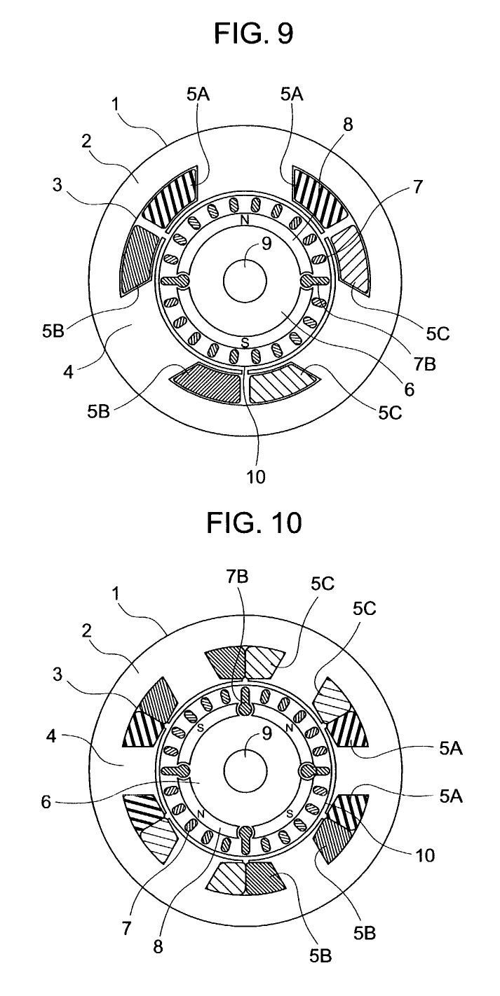

FIG. 9 is a diagram showing a diametrical sectional structure of a self-starting synchronous motor according to yet another embodiment of the invention. In FIG. 9, the same component parts as those in FIGS. 1 and 5 are designated by the same reference numerals, respectively, as in FIGS. 1 and 5, and will not be explained again. The configuration of FIG. 9 is different from those of FIGS. 1 and 5 in that a squirrel-cage conductor 7B having a larger sectional area than the squirrel-cage conductor 7 is arranged between the two poles of each of two permanent magnets 8.

This configuration can produce a similar effect to that of FIG. 5. In addition, the leakage magnetic fluxes (not shown) are prevented from being formed between the poles of the two permanent magnets of different polarities and the effective magnetic fluxes are increased, thereby improving the characteristics more.

FIG. 10 is a diagram showing a diametrical sectional structure of a self-starting synchronous motor according to a further embodiment of the invention. In FIG. 10, the same component parts as those in FIG. 9 are designated by the same reference numerals, respectively, as in FIG. 9 and will not be explained again. The configuration of FIG. 10 is different from that of FIG. 9 in that six slots 3 are formed in the stator core 2 and four permanent magnets 8 of different polarities are buried in the rotor core 6 thereby to make what is called a “4-pole 6-slot” structure.

This configuration can produce a similar effect to that of FIG. 9.

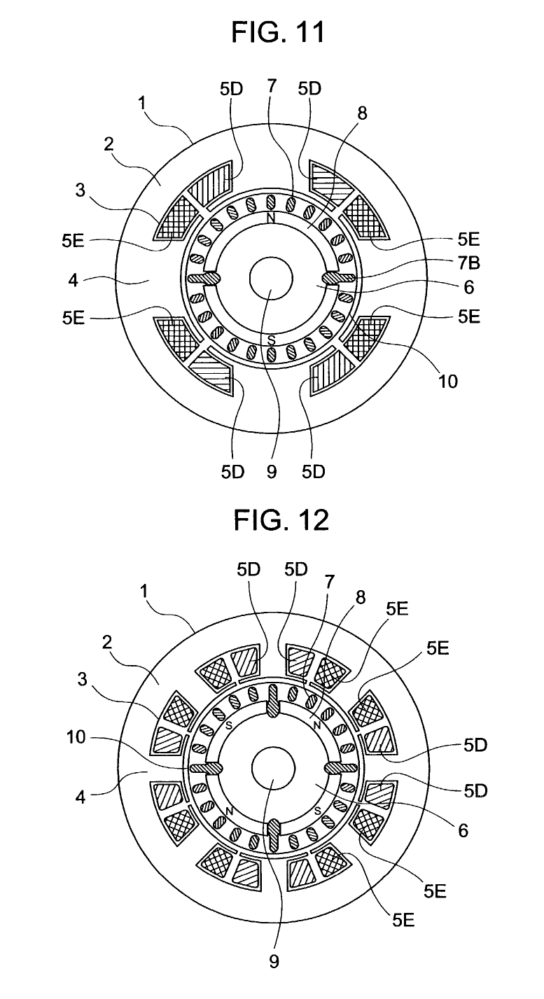

FIG. 11 is a diagram showing a diametrical sectional structure of a self-starting synchronous motor according to a still further embodiment of the invention. In FIG. 11, the same component parts as those in FIG. 9 are designated by the same reference numerals, respectively, as in FIG. 9 and will not be explained again. This configuration is different from that of FIG. 9 in that four slots 3 are formed in the stator core 2 and the armature winding 5 arranged in the slots 3 makes up a single-phase winding including a main winding 5D and an auxiliary winding 5E.

This configuration can produce a similar effect to that of FIG. 9.

FIG. 12 is a diagram showing a diametrical sectional structure of a self-starting synchronous motor according to a yet further embodiment of the invention. In FIG. 12, the same component parts as those in FIG. 10 are designated by the same reference numerals, respectively, as in FIG. 10 and will not be explained again. The configuration of FIG. 12 is different from that of FIG. 10 in that eight slots 3 are formed in the stator core 2 and the armature winding arranged in the slots 3 makes up a single-phase winding including a main winding 5D and an auxiliary winding 5E.

This configuration can produce a similar effect to that of FIG. 8.

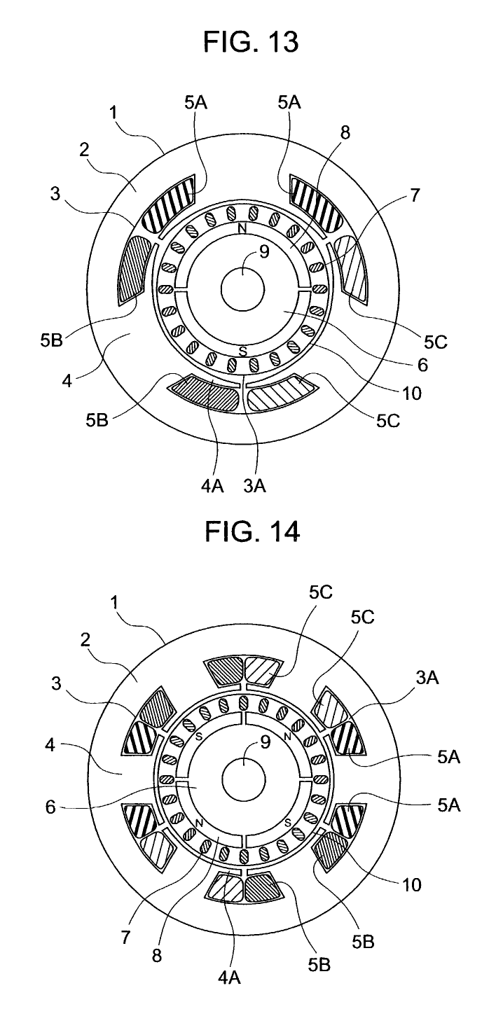

FIG. 13 is a diagram showing a diametrical sectional structure of a self-starting synchronous motor according to still another embodiment of the invention. In FIG. 13, the same component parts as those in FIG. 1 are designated by the same reference numerals, respectively, as in FIG. 1 and will not be explained again. The configuration of FIG. 13 is different from that of FIG. 1 in that the two end portions 4A of each of the teeth 4 are expanded toward the outer diameter, and a disuniform gap is formed between the inner diameter of the stator 1 and the outer diameter of the rotor 10 in such a manner that the length of each gap is large in the neighborhood of the slot opening 3A and small at each peripheral central portion of the teeth 4.

This configuration can produce a similar effect to that of FIG. 1. In addition, the distribution of the magnetic fluxes in the gaps can assume a form more similar to the sinusoidal wave. Thus, the abnormal torque of the induction motor at the time of starting can be reduced, and so can the pulsation torque during the operation of the synchronous motor.

FIG. 14 is a diagram showing a diametrical sectional structure of a self-starting synchronous motor according to a further embodiment of the invention. In FIG. 14, the same component parts as those in FIG. 13 are designated by the same reference numerals, respectively, as in FIG. 13 and will not be explained again. The configuration of FIG. 10 is different from that of FIG. 13 in that six slots 3 are formed in the stator core 2 and four permanent magnets 8 of different polarities are buried in the rotor core 6 thereby to make up what is called a “4-pole 6-slot” structure.

This configuration can produce a similar effect to that of FIG. 13.

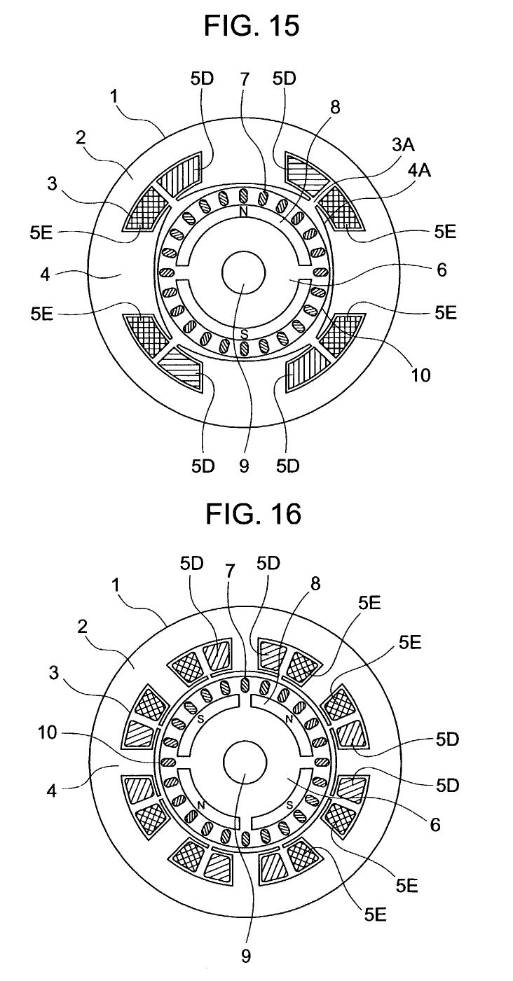

FIG. 15 is a diagram showing a diametrical sectional structure of a self-starting synchronous motor according to a still further embodiment of the invention. In FIG. 15, the same component parts as those in FIG. 13 are designated by the same reference numerals, respectively, as in FIG. 13 and will not be explained again. The configuration of FIG. 15 is different from that of FIG. 13 in that four slots 3 are formed in the stator core 2 and the armature winding 5 arranged in the slots 3 makes up a single-phase winding including a main winding 5D and an auxiliary winding 5E.

This configuration can produce a similar effect to that of FIG. 13.

FIG. 16 is a diagram showing a diametrical sectional structure of a self-starting synchronous motor according to a yet further embodiment of the invention. In FIG. 16, the same component parts as those in FIG. 14 are designated by the same reference numerals, respectively, as in FIG. 14 and will not be explained again. The configuration of FIG. 16 is different from that of FIG. 14 in that eight slots 3 are formed in the stator core 2 and the armature winding 5 arranged in the slots 3 makes up a single-phase winding including a main winding 5D and an auxiliary winding 5E.

This configuration can produce a similar effect to that of FIG. 14.

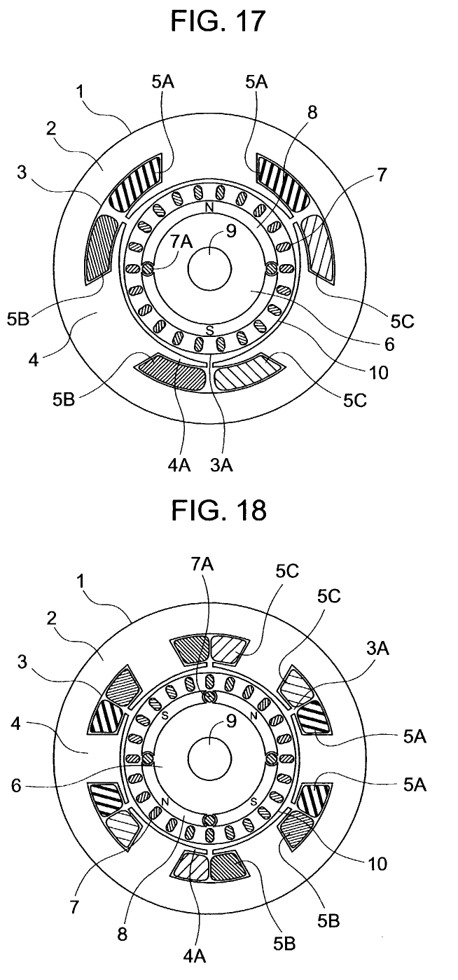

FIG. 17 is a diagram showing a diametrical sectional structure of a self-starting synchronous motor according to still another embodiment of the invention. In FIG. 17, the same component parts as those in FIG. 5 are designated by the same reference numerals, respectively, as in FIG. 5 and will not be explained again. The configuration of FIG. 17 is different from that of FIG. 5 in that the two end portions 4A of each of the teeth 4 are expanded toward the outer diameter, and a disuniform gap is formed between the inner diameter of the stator 1 and the outer diameter of the rotor 10 in such a manner that the gap width is large in the neighborhood of the slot opening 3A and small at the peripheral central portion of each of the teeth 4.

This configuration can produce a similar effect to that of FIG. 5. In addition, the abnormal torque at the time of starting can be reduced, and so can the pulsation torque during the operation.

FIG. 18 is a diagram showing a diametrical sectional structure of a self-starting synchronous motor according to a further embodiment of the invention. In FIG. 18, the same component parts as those in FIG. 17 are designated by the same reference numerals, respectively, as in FIG. 17 and will not be explained again. The configuration of FIG. 18 is different from that of FIG. 17 in that six slots 3 are formed in the stator core 2 and four permanent magnets 8 of different polarities are buried in the rotor core 6 thereby to make up what is called a “4-pole 6-slot” structure.

This configuration can produce a similar effect to that of FIG. 17.

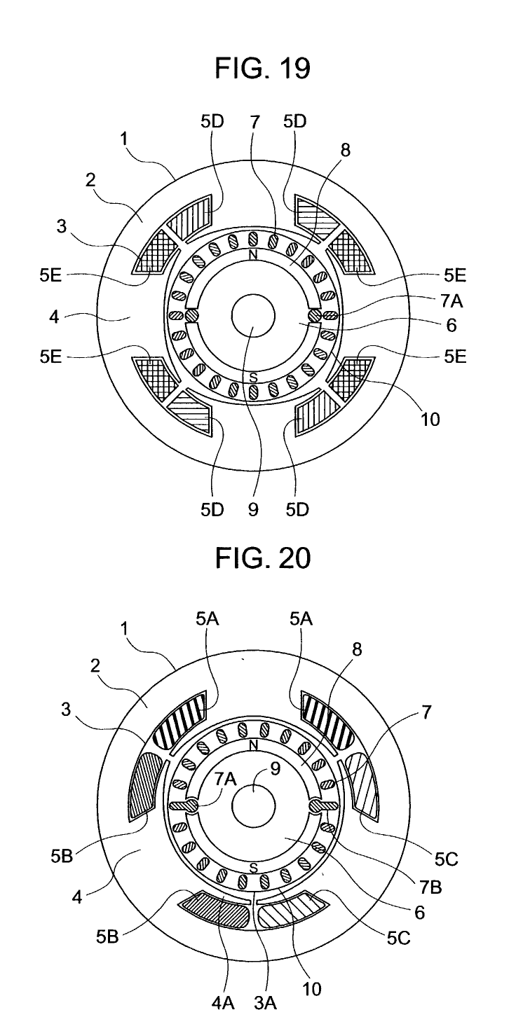

FIG. 19 is a diagram showing a diametrical sectional structure of a self-starting synchronous motor according to a still further embodiment of the invention. In FIG. 19, the same component parts as those in FIG. 17 are designated by the same reference numerals, respectively, as in FIG. 17 and will not be explained again. The configuration of FIG. 19 is different from that of FIG. 17 in that four slots 3 are formed in the stator core 2 and the armature winding 5 arranged in the slots 3 makes up a single-phase winding including a main winding 5D and an auxiliary winding 5E.

This configuration can produce a similar effect to that of FIG. 17.

FIG. 20 is a diagram showing a diametrical sectional structure of a self-starting synchronous motor according to a yet further embodiment of the invention. In FIG. 20, the same component parts as those in FIG. 9 are designated by the same reference numerals, respectively, as in FIG. 9 and will not be explained again. The configuration of FIG. 20 is different from that of FIG. 9 in that the two end portions 4A of each of the teeth 4 are expanded toward the outer diameter, and a disuniform gap is formed between the inner diameter of the stator 1 and the outer diameter of the rotor 10 in such a manner that the gap width is large in the neighborhood of the slot opening 3A and small at the peripheral central portion of each of the teeth 4.

This configuration can produce a similar effect to that of FIG. 9. In addition, the abnormal torque at the time of starting can be reduced, and so can the pulsation torque during the operation.

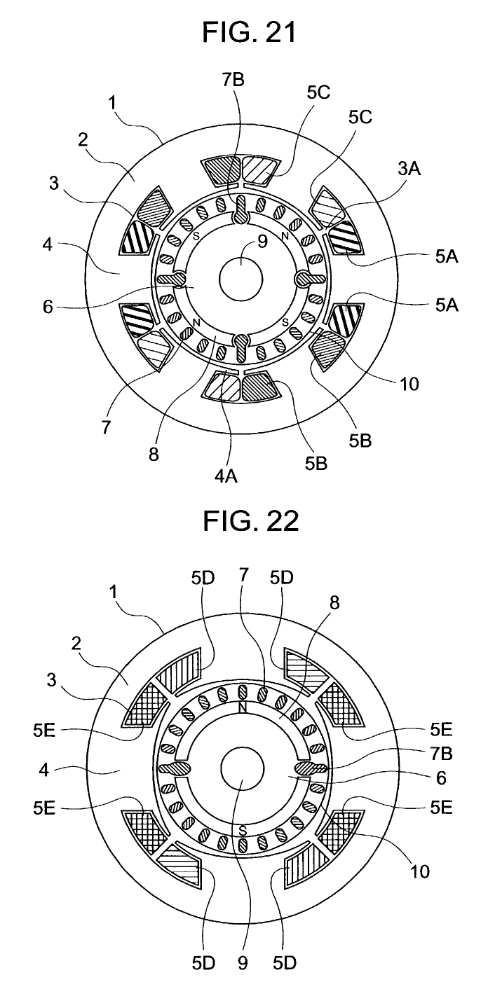

FIG. 21 is a diagram showing a diametrical sectional structure of a self-starting synchronous motor according to still another embodiment of the invention. In FIG. 21, the same component parts as those in FIG. 20 are designated by the same reference numerals, respectively, as in FIG. 20 and will not be explained again. The configuration of FIG. 21 is different from that of FIG. 20 in that six slots 3 are formed in the stator core 2 and four permanent magnets 8 of different polarities are buried in the stator core 6 thereby to make up what is called a “4-pole 6-slot” structure.

This configuration can produce a similar effect to that of FIG. 20.

FIG. 22 is a diagram showing a diametrical sectional structure of a self-starting synchronous motor according to yet another embodiment of the invention. In FIG. 22, the same component parts as those in FIG. 20 are designated by the same reference numerals, respectively, as in FIG. 20 and will not be explained again. The configuration of FIG. 22 is different from that of FIG. 20 in that four slots 3 are formed in the stator core 2 and the armature winding 5 arranged in the slots 3 makes up a single-phase winding including a main winding 5D and an auxiliary winding 5E.

This configuration can produce a similar effect to that of FIG. 20.

According to the embodiments described above, the stator is wound only in concentrated way. Therefore, the size of the coil end portion can be reduced, and the efficiency can be improved as the result of a reduced copper loss in the winding while at the same time making possible a compact motor. Also, only the winding machine of concentration type is used for fabrication of the motor advantageously in terms of cost. Further, since the winding specification is set in conformance with the number of the magnet poles, the torque characteristic is not adversely affected.

Furthermore, in view of the fact that the starting conductor used in the rotor is of squirrel cage type, several advantages are achieved. First, the magnetic gap can be minimized and therefore the effective magnetic fluxes can be secured even under the operation at the rated speed. Secondly, since the induction current flowing in the conductor and the magnetic fluxes flowing into the rotor from the stator side are at right angles to each other, the torque characteristic can be secured. Thirdly, the production line (including the die casting device) for the rotor of the conventional induction motor can be used as it is, and therefore the cost is considerably reduced.

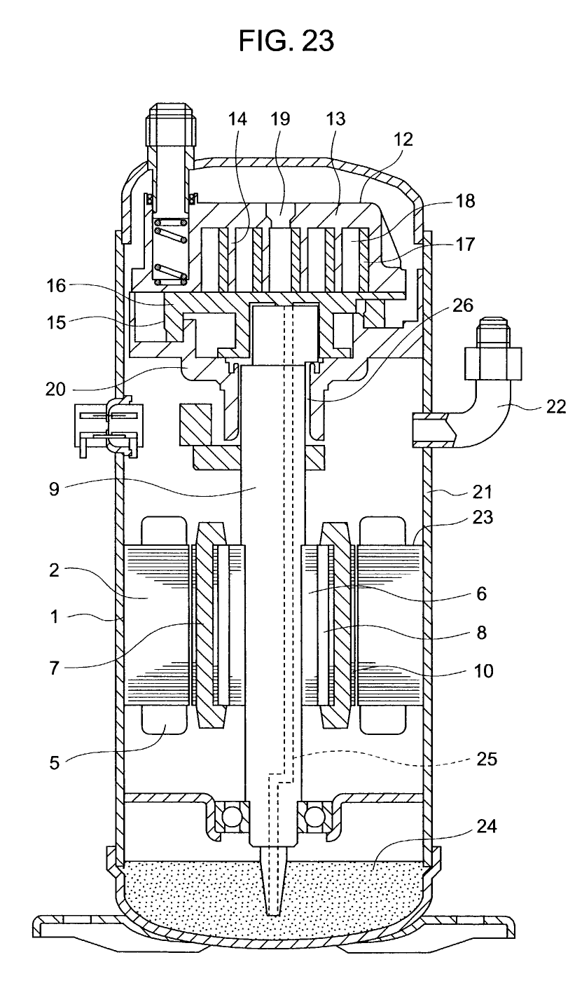

FIG. 23 is a diagram showing a sectional structure of a compressor employing a self-starting synchronous motor according to the invention. A compression mechanism includes a spiral lap 14 formed downright from the end plate 13 of a fixed scroll member 12, in engaged relation with a spiral lap 17 formed upright on the end plate 16 of a swivel scroll member 15. The compress operation is performed by swiveling the swivel scroll member 15 by a crankshaft 9.

Of the compression chambers 18 (18a, 18b and so forth) formed by the fixed scroll member 12 and the swivel scroll member 15, the compression chamber 18 located on the outermost diameter is compressed by the swivel motion in such a manner as to reduce the volume progressively toward the center of the two scroll members 12, 15, so that the compressed gas in the compression chamber 18 is discharged from an outlet 19 communicating with the central portion of the compression chamber 18.

The compressed gas thus discharged enters the part of a pressure vessel 21 under a frame 20 through a gas passage (not shown) formed in the fixed scroll member 12 and the frame 20, and is released out of the compressor by way of a discharge pipe 22 arranged on the side wall of the pressure vessel 21.

In this compressor, a driving motor 23 is sealed in the pressure vessel 21 and adapted to rotate at a constant speed as a prime mover for the compress operation described above.

An oil pool 23 is formed under the driving motor 23. The oil in the oil pool 24 is supplied for lubrication of the sliding part, the sliding bearing 26, etc. between the swivel scroll member 15 and the crankshaft 9 through an oil hole 25 formed in the crankshaft 9.

The driving motor 23, as explained with reference to FIGS. 1 to 14, constitutes a self-starting synchronous motor including the stator 1 and the rotor 10. The stator 1 includes the stator core 2 and the armature winding 5 wound on the stator core 2. The rotor 10 includes the rotor core 6 having a plurality of squirrel-cage conductors 7 and permanent magnets 8 on the crankshaft 9 for the starting operation.

An experiment conducted using the self-starting synchronous motor shown in FIGS. 1 and 2 as the motor 23 shows that the efficiency of the compressor as a whole can be improved by 0.2% as compared with the compressor employing the self-starting synchronous motor of distributed winding type.

According to this invention, a compact, lightweight and highly efficient self-starting synchronous motor can be provided. Also, a compact, lightweight and highly efficient compressor can be provided.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A self-starting synchronous motor comprising a stator core, an armature winding wound on said stator core, a rotor core, at least a magnet buried in said rotor core and at least a squirrel-cage winding arranged on said rotor core,
wherein said armature winding is wound in concentrated way.

2. A self-starting synchronous motor comprising a stator core, an armature winding wound on said stator core, a rotor core, a squirrel-cage winding including at least a conductive material buried in the neighborhood of the outer peripheral portion of said rotor core, and at least a permanent magnet buried inward of said squirrel-cage winding,
wherein said armature winding is wound in concentrated way.

3. A self-starting synchronous motor comprising a stator core, an armature winding wound on said stator core, a rotor core, at least a permanent magnet buried in said rotor core and a squirrel-cage winding arranged on said rotor core,
wherein said armature winding is wound in concentrated way while at the same time constituting a three-phase winding of U, V and W phases.

4. A self-starting synchronous motor comprising a stator core, an armature winding wound on said stator core, a rotor core, at least a permanent magnet buried in said rotor core and a squirrel-cage winding arranged on said rotor core,
wherein said armature winding is wound in concentrated way while at the same time constituting a single-phase or a double-phase winding including a main winding and an auxiliary winding.

5. A self-starting synchronous motor comprising a stator core, an armature winding wound on said stator core, a rotor core, at least a permanent magnet buried in said rotor core and a squirrel-cage winding arranged on said rotor core,
wherein said armature winding is wound in concentrated way and a squirrel-cage conductor is arranged also between the poles of said permanent magnet.

6. A self-starting synchronous motor according to claim 5, wherein the sectional area of said squirrel-cage conductor arranged between said poles is larger than that of the other squirrel-cage conductor.

7. A self-starting synchronous motor comprising a stator core, an armature winding wound on said stator core, a rotor core, at least a permanent magnet buried in said rotor core and a squirrel-cage winding arranged on said rotor core,
wherein said armature winding is wound in concentrated way and at least a disuniform gap is formed between said stator and said rotor.

8. A self-starting synchronous motor according to claim 7, wherein said disuniform gap is wider in the slot opening than at the central position of each of the teeth.

9. A self-starting synchronous motor comprising a stator core, an armature winding wound in a plurality of slots formed in said stator core, a rotor core, a squirrel-cage winding formed by burying a conductive material in each of a plurality of slots formed in the neighborhood of the outer peripheral portion of said rotor core, and a plurality of permanent magnets buried in the inner periphery of said squirrel-cage winding,
wherein said armature winding is wound in concentrated way, and a disuniform gap wider at the slot opening than at the central position of each of the teeth is formed between said stator and said rotor.

10. A self-starting synchronous motor according to claim 2, wherein said magnet is a substantially arcuate permanent magnet.

11. A self-starting synchronous motor according to claim 2, further comprising means for supplying power to said armature winding of concentrated type at the time of starting and acceleration using the torque of the induction motor.

12. A compressor comprising:
a motor including a stator core, an armature winding wound on said stator core, a rotor core, a squirrel-cage winding formed by burying at least a conductive material in the neighborhood of the outer peripheral portion of said rotor core and at least a permanent magnet buried inward of said squirrel-cage winding, and
a compressor mechanism driven by said motor for absorbing, compressing and discharging a refrigerant.
